(19) United States
(12) Patent Application Publication
(10) Pub. No.: US 2026/0225720 A1
(43) Pub. Date: Aug. 6, 2026

(54) METHOD FOR CONTROLLING ANTI-ICING MEANS IN AN AIRCRAFT AS A FUNCTION OF THE ICE ACCRETION RATE, AND CORRESPONDING SYSTEM

(71) Applicant: SAFRAN AEROSYSTEMS, Plaisir (FR)

(72) Inventors: Stéphane LE GARREC, Moissy-Cramayel (FR); Bruno Pierre Louis THILLAYS, Moissy-Cramayel (FR); Fiona Marie Joëlle MARTINACHE, Moissy-Cramayel (FR); Philippe PORTIER, Moissy-Cramayel (FR); Annagrazia ORAZZO, Moissy-Cramayel (FR)

(73) Assignee: SAFRAN AEROSYSTEMS, Plaisir (FR)

(21) Appl. No.: 19/154,327

(22) PCT Filed: Feb. 8, 2024
(86) PCT No.: PCT/FR2024/050173

§ 371 Date: Aug. 6, 2025

(30) Foreign Application Priority Data
Feb. 9, 2023 (FR) 2301227

(51) Int. Cl. B64D 15/22; B64D 15/12; B64D 15/16; B64D 33/02

(52) U.S. Cl. CPC B64D 15/22; B64D 15/12; B64D 15/16; B64D 2033/0233

(57) ABSTRACT

A method for controlling an anti-icing device protecting at least one outer surface of an aircraft, the device being provided with at least one anti-icing means and with a means for measuring the ice accretion rate, comprising steps of determining at least one parameter for the activation of the at least one anti-icing means as a function of the ice accretion rate determined by the measurement means, in order to prevent the accretion of ice on the at least one outer surface to be protected or in order to reduce the thickness of ice accreted on the at least one outer surface to be protected.

### TECHNICAL FIELD

The technical field of the invention is a device for controlling anti-icing means, and more particularly such a control device coupled to a device for detecting icy conditions.

### PRIOR ART

An aircraft may be subject to icing phenomena when it operates under certain atmospheric conditions, in particular at temperatures close to and below freezing point and in a humid atmosphere. The latter condition is met in particular when the aircraft goes through certain types of clouds.

The formation of ice can block moving surfaces of the aircraft such as leading edges, flaps and tail assemblies, and reduce the performance of the aircraft's engines or even damage its components.

The formation of ice can also lead to loss of lift and increased drag, which may be critical for the aircraft.

To avoid such consequences, anti-icing means have been developed. These are in particular thermal elements arranged on the surfaces to be protected. They can be used preventively, i.e. in the “anti-icing” mode, by keeping the temperature of these surfaces above the melting point of water. They can be used curatively, in the “de-icing” mode, by intermittently heating the considered surfaces to enable the built-up ice to detach. The thermal elements may be electrical, using the Joule effect, but are more commonly hot air circulating thermal elements, using the hot air coming from the motors. This type of thermal element using hot air circulation is used only in the “anti-icing” mode. This is effective against icing, but cannot be controlled precisely and specifically and is accompanied by significant heat loss, and consequently increased fuel consumption.

As regards systems using electrical elements, they can be used in both “anti-icing” and “de-icing” modes on the same aircraft.

The anti-icing means may also comprise mechanical means, for example in the form of inflatable cylinders, arranged on the surface to be protected, and inflated periodically in order to mechanically break the accumulated ice.

In addition, various ice detectors have been developed over the years. While most ice detectors give a binary detection result (presence or absence of ice conditions), the most advanced detectors are capable of providing information about the intensity of the ice conditions encountered by measuring the ice accretion rate (IAR). Document U.S. Pat. No. 8,704,181B2, in the name of the applicant, discloses such a detector.

The icing prevention and anti-icing means is activated by the aircraft pilot, as soon as the detector indicates icy conditions. These activations therefore do not really take into account the ice accretion rate, and indifferently apply the energy required for maximum protection.

Such operation is not optimised, especially in the context of energy savings and the longevity of the de-icing means. The activation of the thermal elements in particular is particularly energy-intensive.

Climate change is a major concern for many legislative and regulatory bodies throughout the world. Indeed, various restrictions on carbon emissions have been, are or will be adopted by various states. In particular, an ambitious standard applies both to new types of aeroplanes and those already in service, requiring the implementation of technological solutions in order to make them compliant with current regulations. Civil aviation has been working for several years now to make its contribution to the fight against climate change.

Technological research efforts have already led to significant improvements in the environmental performance of aeroplanes. The Applicant takes account of the impacting factors in all the design and development phases to obtain aeronautical components and products that consume less energy, are more environmentally friendly and whose integration and use in civil aviation have moderate environmental consequences with the purpose of improving the energy efficiency of aeroplanes.

As a result, the Applicant is constantly working to reduce its negative climate impact by using virtuous development and manufacturing methods and processes that minimise greenhouse gas emissions as much as possible to reduce the environmental footprint of its business.

These sustained research and development works cover the new generations of aircraft engines, the lightening of aircraft, in particular through the materials used and the lighter on-board equipment, the development of the use of electrical technologies to ensure propulsion, and, essential complements to technological progress, aviation biofuels.

To this end, the invention is the result of technological researches aimed at significantly improving the performances of airplanes through energy saving and, accordingly, contributes to the reduction of the environmental impact of airplanes.

There is therefore a need for a system for controlling anti-icing means capable of activating said systems as a function of the ice accretion rate.

### DISCLOSURE OF THE INVENTION

The object of the invention is a method for controlling an anti-icing device protecting at least one outer surface of an aircraft, the device being provided with at least one anti-icing means and a means for measuring the ice accretion rate, comprising steps of determining at least one activation parameter of the at least one anti-icing means as a function of the ice accretion rate determined by the measuring means in order to prevent the accretion of ice on the at least one outer surface to be protected or in order to reduce the thickness of the ice accumulated on the at least one outer surface to be protected.

As the at least one anti-icing means comprises at least one anti-icing means with heating element, the method of controlling may comprise the following steps:
determining a power density as a function of the ice accretion rate, the attitude of the aircraft, the flow velocity and the air of the total ambient temperature received from a flight computer, and a predetermined temperature setpoint, and
controlling an actuator of the at least one anti-icing means with heating element such that a power as a function of the determined power density is transmitted to the anti-icing means with heating element so as to prevent the formation of ice on the anti-icing means with heating element.

As the at least one anti-icing means comprises at least one anti-icing means with heating element and/or at least one anti-icing means with mechanical element, the control method may comprise the following steps:
determining a duration between two activations as a function of the ice accretion rate, a correlation factor between the ice accretion rate measured by measuring the ice accretion rate and the ice accretion rate at the outer surface to be protected and the maximum tolerated ice thickness,
controlling an actuator of an anti-icing means each time the determined duration between two activations elapses, so as to reduce the thickness of ice formed on the at least one outer surface to be protected.

The correlation factor may depend on the attitude of the aircraft, the air flow velocity, the static ambient temperature, the rotational speed of the propulsion unit and the true speed of the aircraft.

The air flow velocity may be equal to the true air speed when the anti-icing means is disposed on a wing leading edge or on a rear tail unit of an aircraft, or depends on the true air speed and the rotational velocity of the propulsion unit when the anti-icing means is disposed on an engine air inlet, a blade of an engine or a blade of a rotary wing.

The invention also relates to a system for controlling an anti-icing device protecting at least one outer surface of an aircraft, the device being provided with at least one anti-icing means and a means for measuring the ice accretion rate, the controlling system comprising a control means connected as input to a flight computer, said flight computer being connected to a set of measuring means, comprising in particular a means for measuring the ice accretion rate, said flight computer being connected as output to at least one of said anti-icing means, the control means being capable of executing the controlling method as described above.

An anti-icing means may be chosen from an anti-icing means with heating element and an anti-icing means with mechanical element.

### BRIEF DESCRIPTION OF THE DRAWINGS

Other purposes, characteristics and advantages of the invention will become apparent upon reading the following description, provided solely as a non-limiting example and with reference to the appended drawings in which:

FIG. 1 illustrates the main elements of a system for controlling anti-icing means according to the invention,

FIG. 2 illustrates the duration between two activations of an anti-icing means,

FIG. 3 illustrates the evolution of the ice thickness as a function of the time and the duration between two activations of an anti-icing means, and

FIG. 4 illustrates the difference between the air flow at the means for measuring the ice accretion rate and the flow at the zone to be protected.

### DETAILED DESCRIPTION

A system for controlling the de-icing means 1 according to the invention comprises a control means 2 connected as input to a flight computer 3 and to a means 4 for measuring the ice accretion rate, and as output to at least one anti-icing means 5,6.

The anti-icing means 5,6 comprise at least one amongst an anti-icing means with heating element 5, and an anti-icing means with mechanical element 6.

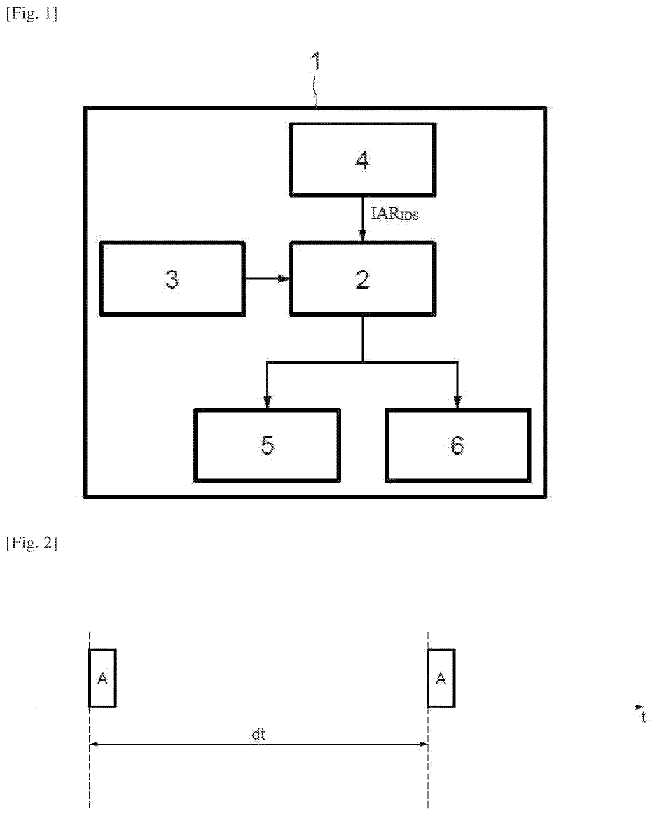

FIG. 1 illustrates such a system for controlling de-icing means.

In one operating mode, the control means 2 controls an anti-icing means with heating element 5 in the “anti-icing” mode. In other words, the aim is to prevent the formation of ice.

In this “anti-icing” control mode, a sufficient power density dP to be applied is determined, taking into account accretion rate information so as to optimise, i.e. adjust reduce the electrical power to be used (consumed) so as to produce sufficient heating to prevent the formation of ice on the outer surface of the aircraft to be protected. This temperature to be reached, and therefore the power to be supplied, will depend on the desired type of anti-icing, i.e. dripping, with the impacting droplets remaining liquid, or evaporative, with the droplets being evaporated upon impact

To achieve this, the control means 2 determines the power P to be supplied by the anti-icing means with heating element 5, according to the data received from the flight computer 3 and the means 4 for measuring the ice accretion rate.

The power P is the product of the area S of the area to be protected by the power density dP, given by applying the following equation:

$$d P = {Q}_{c o n v} + {Q}_{e v p} + {Q}_{d i rection} - {Q}_{{k}_{a e r o}} - {Q}_{{k}_{d r o p}} \qquad [ Math 1 ]$$

Where:
Q_{conv}: the heat exchanged by convection between the protected surface and the air flow in contact with this surface and the means 4 for measuring the ice accretion rate;
Qₑᵥₚ: the heat due to evaporation of water droplets in contact with the protected surface;
Q_{direction}: the heat required to change the temperature of the water in contact with the protected surface;
Qₖ_{ₐₑᵣₒ}: the heat due to aerodynamic heating of the flow on the protected surface;
Qₖ_{_{drop}}: the heat due to the kinetic energy of the droplets in contact with the protected surface.

The Meier & Scholz document. “A Handbook method for the estimation of power requirements for electrical de-icing systems.” DLRK, Hamburg, 31 Aug.-2 Sep. 2010 describes methods for evaluating the terms of the energy balance of the equation [Math 1]. In the first approach, this power density dP is determined according to the following parameters:

$$d P = f ( L W {C}_{∞} , {β}_{l o c} , A l t , A T T , {V}_{e} , Temp , {T}_{surf \_ target} ) \qquad [ Math 2 ]$$

Where:
dP: Power density in W/cm²;
LW C_{∞}: Liquid Water Content or water concentration of the cloud encountered by the aircraft (g/m³);
β_{loc}: Capture coefficient of the area to be protected linked to its geometric shape, the size of droplets present in the cloud encountered, and the speed and attitude of the aircraft. Without dimension between 0 and 1;
ATT: Aircraft attitude, incidence or flight phase, directly influencing the capture zone;
Vₑ: Air flow velocity
Temp: Total ambient (TAT) or static temperature (SAT);
T_{surf_target}: Surface temperature threshold to be reached in order to obtain the anti-icing effect depending on whether it will be dripping or evaporating.

It should be noted that the air flow velocity Ve can be defined as a function of the location of the anti-icing means.

The air flow velocity Ve is equal to the True Air Speed (TAS) for the leading edges of the wings and the rear tail units.

The air flow velocity Ve is equal to a combination of the true air speed of the aircraft TAS and of the rotational speed of the propeller ER (acronym standing for “Engine Round per minute”) for engine air inlets, the blades of an engine or the rotary wing of a helicopter.

In order to solve the energy balance equation, the water concentration value LW C_{∞} of the cloud and the capture coefficient must be known β_{loc}. The other parameters are given by the avionics systems, with the exception of the surface temperature threshold T_{onƒ}_{_{target}}, a constant value chosen at the time of the design of the anti-icing means with heating element 5.

The ice accretion IAR_{IDS} rate information can be obtained analytically via the following equation:

The detector IAR is given analytically by the following equation:

$${IAR}_{IDS} = \frac{TAS \cdot {LWC}_{IDS} \cdot {β}_{IDS} \cdot {η}_{IDS}}{{ρ}_{i}} \qquad [ Math 3 ]$$

Where
   TAS=True Air Speed (m/s)
   LWC=Liquid Water Content or water concentration near the detector (g/m³)
   β_{IDS}=capture coefficient on the reference surface of the ice detector
   η_{IDS}=Freezing Fraction (FF), which is a dimensionless coefficient between 0 and 1, indicating the portion of water that will freeze over the surface of the detector.
   ρᵢ=density of the ice (g/m³), typically ρᵢ-917000 g/m³

The β_{IDS} capture coefficient on the reference surface of the ice detector is a function of the surface geometry, the diameter of droplets present in the icy cloud and their trajectory (i.e. a function of the speed and drag force exerted on the droplets). It is a dimensionless coefficient between 0 and 1 that indicates the impact surface of droplets where ice can accumulate.

This coefficient β_{IDS} can be evaluated with numerical simulations of water capture on the reference surface of the ice detector and the freezing fraction η_{IDS} thanks to ice accretion simulations based on the resolution of the Messinger balance equations (Messinger, B. L. (1953). “Equilibrium Temperature of an Unheated Icing Surface as a Function of Air Speed”. Journal of the Aeronautical Sciences, 20(1), 29-42. doi: 10.2514/8.2520).

The ice detector, following the guidelines given by ED103revB (EUROCAE ED103. “Minimum Operational Performance Standard for Inflight Icing Detection Systems”. Revision B, April 2022) and Appendix K of AC 20-73A (FAA “Advisory Circular 20-73A. Aircraft Ice Protection”) dated 16 Apr. 2006, must be installed on the aircraft in a position that allows it to measure an IAR representative of the IAR_{∞} upstream infinite flow, where

$${IAR}_{∞} = ( TAS \cdot {LWC}_{∞} ) / {ρ}_{i} \qquad [ Math 4 ]$$

With IAR_{∞} expressed in m/s

When the value IAR_{IDS} tends towards the value IAR_{∞}, the value η_{IDS} tends towards 1, the value BIDS also tends towards 1, and the LWC value tends towards the value LW C_{∞}.

As defined in ED103revB, the ice detector must be able to provide an IAR measurement with the following accuracy:

$${IAR}_{IDS} = {IAR}_{∞} \pm 30 \% {IAR}_{∞} \qquad [ Math 5 ]$$

The information given by the means 4 for measuring the ice accretion rate makes it possible to calculate the water LW C_{∞} concentration value of the cloud to be used for the energy balance:

$$L W {C}_{∞} \approx \frac{{IAR}_{IDS} \cdot {ρ}_{i}}{T A S} \qquad [ Math 6 ]$$

The capture coefficient β_{loc} can be considered equal to 1 in order to be conservative.

This LWC value can thus be used by the formula [Math 2] to calculate the minimum power density to be applied to the surface to be protected.

Thus, a power density dP is determined continuously as has just been stated, as a function of the IAR measurement, which is transmitted as a control input of the actuators of the anti-icing means with heating element 5, and that being so as long as the IAR value is not zero.

The “anti-icing” control mode remains, in principle, very energy-intensive.

Another control mode, so-called “de-icing” control mode, allows reducing this consumption if the accretion of a certain thickness of ice is tolerated. This thickness must be defined by the aircraft manufacturer. Thus, it is provided that the control means 2 controls an anti-icing means 5,6 in the de-icing mode.

The “de-icing” control mode enables the deposit or accretion of ice, with a thickness compatible with flight safety. Thus, the accumulated ice is periodically removed before its maximum permissible thickness is reached.

Indeed, the “de-icing” mode can:
use anti-icing means with heating element 5, such as those used in the “anti-icing” control mode disclosed before, but with cyclical, intense activation, and/or
use anti-icing means with mechanical element 6, also with cyclical activation, in order to break the accumulated ice.

In particular, the anti-icing means with mechanical element 6 are actuators of the “inflatable cylinder” type.

It is proposed, in the present invention, to optimise this cyclical activation, by determining the time interval dT between two activations A as illustrated in FIG. 2.

FIG. 2 illustrates the time interval dt between two activations A of an anti-icing means 5, 6 in the “de-icing” mode. This time interval dt, also called duration dt, between two activations, is defined by the following equation:

$$d t = \frac{τ}{{IAR}_{l o c}} ( s ) \qquad [ Math 7 ]$$

τ: ice thickness (in m).
IAR_{loc}: Ice accretion rate of the surface to be protected (in m/s).

It should be noted that the thickness of the ice τ must be between a minimum required thickness for effective de-icing and a maximum tolerable thickness for safety and ensuring optimum performance of the anti-icing means.

Knowledge of the ice accretion rate makes it possible to activate the anti-icing means with heating element within a time window such that the thickness of the ice deposit is between this minimum threshold (the minimum required thickness for effective de-icing, notably 2 mm) and this maximum permissible threshold for aircraft safety (the maximum tolerable thickness, notably 5 mm). The rate of activations (e.g. de-icings) thus becomes dependent on the ice accretion rate.

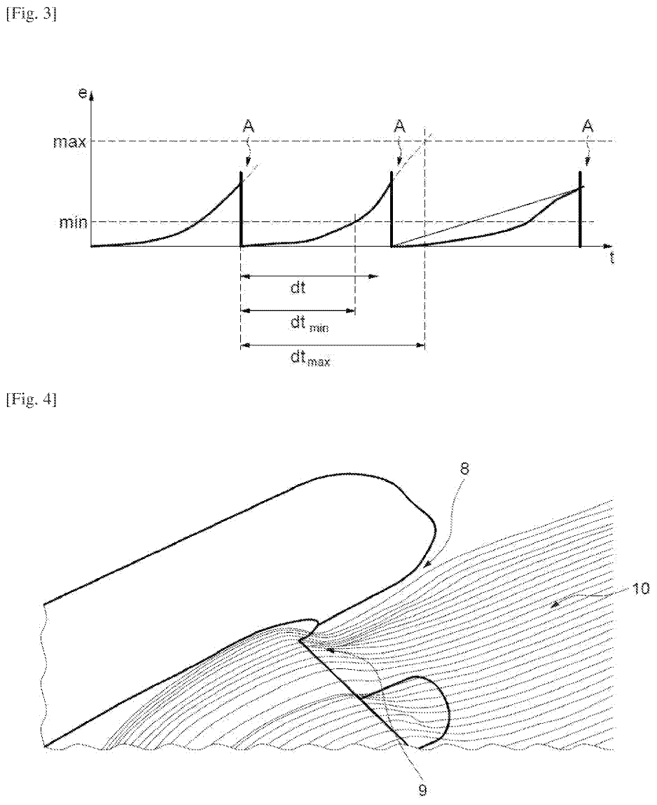

FIG. 3 illustrates the evolution of the ice thickness e over time, the minimum ice thickness eₘᵢₙ, the maximum ice thickness eₘₐₓ, as well as the duration dt between two activations A of the anti-icing means. Each time the anti-icing means is activated, the ice thickness is reduced to a negligible value. The ice accretion trend curves are also shown in FIG. 3. Because of the progressive growth of the ice, it is understood that the intercycle duration dt, i.e. the time interval between two activations, varies between a minimum value dtₘᵢₙ when the second activation takes place as soon as the ice thickness is equal to the minimum value eₘᵢₙ and a maximum value dtₘₐₓ when the second activation takes place when the ice thickness reaches the maximum value eₘₐₓ. The duration dt between two activations of the anti-icing means must therefore be chosen between this minimum value dtₘᵢₙ and the maximum value dtₘₐₓ. This adjustment of the duration dt results from a strategy that makes it possible to optimise energy performance, without compromising the safety and aerodynamic performance of the aircraft.

The above equation [Math 7] does not take into account the duration of activation of the anti-icing means. This activation duration must be significantly shorter than the duration dt of the intercycle (a few seconds at most), so as to limit the number of actuators activated simultaneously on the entire aircraft and to preserve the energy saving provided by the “de-icing” mode. It should be noted that the duration of activation of the anti-icing means is not related to the IAR. In addition, this duration depends heavily on the technology of the anti-icing means.

FIG. 4 illustrates the difference between the position 8 of a means 4 for measuring the ice accretion rate and the position 9 of a surface to be protected. The air flow common to the means 4 for measuring the ice accretion rate and to the surface to be protected is also illustrated and referenced 10.

Since the means 4 for measuring the ice accretion rate IAR_{IDS} is installed in a different area of the surface to be protected, the measurement of the ice accretion rate IAR_{IDS} received from the measuring means 4 must be correlated with the value of the ice accretion rate IAR_{loc} at the surface to be protected to be applied in the equation [Math 7]. This allows determining the most suitable intercycle duration dt, i.e. the time interval dt (or) between two activations A of the most suitable anti-icing means 5, 6. The following equation accounts for this correlation.

$${IAR}_{l o c} = C \cdot {IAR}_{IDS} \qquad [ Math 8 ]$$

The correlation coefficient C is given by the following equation:

$$C = f ( {V}_{e} , ATT , SAT ) \qquad [ Math 9 ]$$

In order to determine the function f for evaluating the coefficient C, the following method steps can be carried out:
1. Identify at least one of the most critical flight conditions for the aircraft,
2. For each critical flight condition, perform an aerodynamic simulation and water capture simulations of the aircraft with the means 4 for measuring the ice accretion rate installed. Water capture simulation means a two-phase simulation in an aerodynamic field in which a droplet distribution is injected representing an icy cloud encountered by the aircraft.
3. For each flight condition analysed and each capture simulation, evaluate the ice accretion rate IAR_{IDS} measured by means 4 for measuring the ice accretion rate and the ice accretion rate IAR_{loc} of the surface to be protected. For the evaluation of the accretion rate of the surface to be protected, analytical formulas can be used as described in the aforementioned Messinger publication (B. L. (1953). “Equilibrium Temperature of an Unheated Icing Surface as a Function of Air Speed”. Journal of the Aeronautical Sciences, 20(1), 29-42. doi: 10.2514/8.2520), or ice accretion simulations performed with dedicated tools.
4. Based on the results of these simulations, use a linear regression approach to determine a polynomial approximation of the coefficient C. The following equation accounts for such linear regression:

$$C = \frac{{IAR}_{l o c}}{{IAR}_{IDS}} = {b}_{0} + {b}_{1} T A S + {b}_{2} S A T + {b}_{3} E R + {b}_{4} A T T \qquad [ Math 10 ]$$

The coefficients b₀, b₁, b₂, b₃, b₄ found with the methodology described above are valid only for the aircraft analysed and the area to be protected considered.

Knowing the correlation factor C, it is possible to determine the inter-cycle duration dt as a function of the value of the ice accretion rate IAR_{IDS} received from the means 4 for measuring the ice accretion rate by applying the following equation:

$$d t = \frac{τ}{C \cdot {IAR}_{IDS}} \qquad [ Math 11 ]$$

As indicated before, this intercycle duration dt, between two activations of the anti-icing means 5, 6, is comprised between a required minimum time for a minimum ice thickness to be accumulated and a maximum time corresponding to the maximum acceptable ice thickness for the protected area.

The minimum ice thickness corresponds to the minimum required thickness for the actuator to be in its effective range. In particular, when the anti-icing means is a mechanical process, it is common that its effectiveness only applies beyond a minimum ice thickness.

The maximum ice thickness corresponds to the maximum thickness that can be treated by the anti-icing means, above which the anti-icing means is no longer effective. However, the maximum ice thickness generally corresponds to the maximum value that can be tolerated by the aircraft, for technical, safety or regulatory reasons.

In one embodiment, the control means 2 periodically controls an anti-icing means with mechanical element 6, in a “de-icing” control mode, in order to break the ice present over the protected surface. The control of such means may be employed alone or in combination with the control of anti-icing means with heating element 5. The pieces of broken ice are then carried away by the air flow.

To achieve this, the control means 2 determines an intercycle duration dt, between two activations, by applying the above equation [Math 7], similarly to the determination of the duration between two activations for an anti-icing means with heating element 5. Thus, the determined intercycle duration dt then depends on the characteristics specific to the anti-icing means with mechanical element 6, in particular the minimum and maximum ice thicknesses with which the anti-icing means with mechanical element 6 can operate. The duration dt thus determined, elapsing between two activations of the anti-icing means with mechanical element 6, may thus be different from the determined duration dt elapsing between two activations of an anti-icing means with heating element 5. Indeed, in relation to the determination of the intercycle duration dt between two activations of an anti-icing means with heating element 5, the size of the pieces of broken ice must be taken into account. In order to limit the size of the pieces of ice thus carried away by the action of the anti-icing means with mechanical element 6, the intercycle duration dt should be limited according to the IAR, so that the thickness of the broken ice does not exceed the permitted limit.

1. Method for controlling an anti-icing device protecting at least one outer surface of an aircraft, the device being provided with at least one anti-icing means and a means for measuring the ice accretion rate, the at least one anti-icing means comprising at least one anti-icing means with a heating element and/or at least one anti-icing means with a mechanical element, the control method comprising steps of determining at least one activation parameter of the at least one anti-icing means as a function of the ice accretion rate determined by the measuring means in order to prevent the accretion of ice over the at least one outer surface to be protected or in order to reduce the thickness of the ice accumulated over the at least one outer surface to be protected, the control method further comprising the following steps:
determining a duration between two activations as a function of the ice accretion rate, a correlation factor between the ice accretion rate measured by the measurement of the ice accretion rate and the ice accretion rate at the outer surface to be protected, and a maximum tolerated ice thickness; and
controlling an actuator of an anti-icing means each time the determined duration between two activations elapses, so as to reduce the thickness of ice formed on the at least one outer surface to be protected.

2. Method for controlling an anti-icing device in an aircraft according to claim 1, the at least one anti-icing means comprising at least one anti-icing means with the heating element, the control method comprising the following steps:
determining a power density as a function of the ice accretion rate, the attitude of the aircraft, the flow velocity and the air of the total ambient temperature received from a flight computer, and a predetermined temperature setpoint; and
controlling an actuator of the at least one anti-icing means with the heating element such that a power as a function of the determined power density is transmitted to the anti-icing means with the heating element so as to prevent the formation of ice on the anti-icing means with the heating element.

3. (canceled)

4. Method for controlling an anti-icing device in an aircraft according to claim 1, wherein the correlation factor depends on the attitude of the aircraft, the air flow velocity, the static ambient temperature, the rotational speed of the propulsion unit and the true speed of the aircraft.

5. Method for controlling an anti-icing device in an aircraft according to claim 1, wherein the air flow velocity is equal to the true air speed when the anti-icing means is disposed on a wing leading edge or on a rear tail unit of an aircraft or depends on the true air speed and the rotational velocity of the propulsion unit when the anti-icing means is disposed on an engine air inlet, a blade of an engine or a blade of a rotary wing.

6. System for controlling an anti-icing device protecting at least one outer surface of an aircraft, the device being provided with at least one anti-icing means and a means for measuring the ice accretion rate, the control system comprising a control means connected as input to a flight computer, said flight computer being connected to a set of measuring means, comprising a means for measuring the ice accretion rate, said flight computer being connected as output to at least one of said anti-icing means, wherein the control means is capable of executing the control method according to claim 1.

7. Control system according to claim 6, wherein an anti-icing means is selected amongst an anti-icing means with the heating element and an anti-icing means with the mechanical element.
